(19) United States
(12) Patent Application Publication
(10) Pub. No.: US 2026/0093896 A1
(43) Pub. Date: Apr. 2, 2026

(54) INFORMATION PROCESSING APPARATUS, SYSTEM, AND INFORMATION TERMINAL

(71) Applicant: Yuka HIEI, Kanagawa (JP)

(72) Inventor: Yuka HIEI, Kanagawa (JP)

(21) Appl. No.: 19/328,282

(22) Filed: Sep. 15, 2025

(30) Foreign Application Priority Data
Sep. 30, 2024 (JP) 2024-169889
Jun. 27, 2025 (JP) 2025-109128

(51) Int. Cl. G06F 40/14

(52) U.S. Cl. CPC G06F 40/14

(57) ABSTRACT

An apparatus, a system, and a method each of which acquires a difference between a time spent by a user to perform a particular work using an application and a time spent by the user to perform the particular work without using the application, acquires a reduction effect achieved by use of the application in a predetermined period that is calculated based on a use history of the application and the difference, and outputs a screen that displays the reduction effect.

### CROSS-REFERENCE TO RELATED APPLICATIONS

This patent application is based on and claims priority pursuant to 35 U.S.C. § 119(a) to Japanese Patent Application Nos. 2024-169889, filed on Sep. 30, 2024, and 2025-109128, filed on Jun. 27, 2025, in the Japan Patent Office, the entire disclosure of each are hereby incorporated by reference herein.

### BACKGROUND

### Technical Field

The present disclosure relates to an information processing apparatus, a system, and an information terminal.

### Related Art

Techniques are studied, which quantitatively evaluate the efficiency of a work through implementing a system with search functionality.

Further, no-code or low-code tools that assist the creation of applications are widely used. Such tools allow a user to easily create the application that can record the values input to the preset fields by arranging the fields on an application screen.

### SUMMARY

The present disclosure described herein provides an apparatus, a system, and a method, each of which acquires a difference between a time spent by a user to perform a particular work using an application and a time spent by the user to perform the particular work without using the application, acquires a reduction effect achieved by use of the application in a predetermined period that is calculated based on a use history of the application and the difference, and outputs a screen that displays the reduction effect.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of a system according to a first embodiment;

FIG. 2 is a diagram illustrating an example of a hardware configuration of an implementation effect calculation apparatus according to the first embodiment;

FIG. 3 is a diagram illustrating an example of a functional configuration of an application creation apparatus and the implementation effect calculation apparatus according to the first embodiment;

FIG. 4 is a diagram illustrating a display example of a home screen of an application creation service;

FIG. 5 is a diagram illustrating a display example of a business application creation screen;

FIG. 6 is a diagram illustrating a display example of the business application creation screen after a business application creation work is finished;

FIG. 7 is a sequence diagram of a business application creation process according to the first embodiment;

FIG. 8 is a diagram illustrating an example of the home screen updated after the business application is created;

FIG. 9 is a diagram illustrating a display example of an application initial screen;

FIG. 10 is a diagram illustrating a display example of an application screen;

FIG. 11 is a sequence diagram of an example process to be performed with execution of the business application;

FIGS. 12A and 12B are diagrams each illustrating an example of a configuration of a customer management database (DB);

FIG. 13 is a diagram illustrating an example of a configuration of an operation log storage unit;

FIG. 14 is a diagram illustrating a display example of the application initial screen when one or more records are present;

FIG. 15 is a sequence diagram of an implementation effect calculation process for the business application according to the first embodiment;

FIG. 16 is a diagram illustrating a display example of a spent time setting screen according to the first embodiment;

FIG. 17 is a diagram illustrating a display example of an implementation effect calculation instruction screen according to the first embodiment;

FIG. 18 is a diagram illustrating a display example of an implementation effect output screen according to the first embodiment;

FIG. 19 is a flowchart of an example of a number-of-records acquisition process and the implementation effect calculation process for the business application according to the first embodiment;

FIG. 20 is a flowchart of an example of a number-of-records acquisition process and an implementation effect calculation process for a business application according to a second embodiment;

FIG. 21 is a diagram illustrating a display example of a spent time setting screen according to a third embodiment;

FIG. 22 is a flowchart of an example of a number-of-records acquisition process and an implementation effect calculation process for a business application according to a third embodiment;

FIG. 23 is a diagram illustrating a display example of an implementation effect output screen according to the third embodiment;

FIG. 24 is a diagram illustrating an example of a functional configuration of a user terminal according to a fifth embodiment;

FIG. 25 is a sequence diagram of an example of an implementation effect calculation process for a business application according to the fifth embodiment; and

FIG. 26 is a sequence diagram of an example of an implementation effect calculation process for a business application according to a sixth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

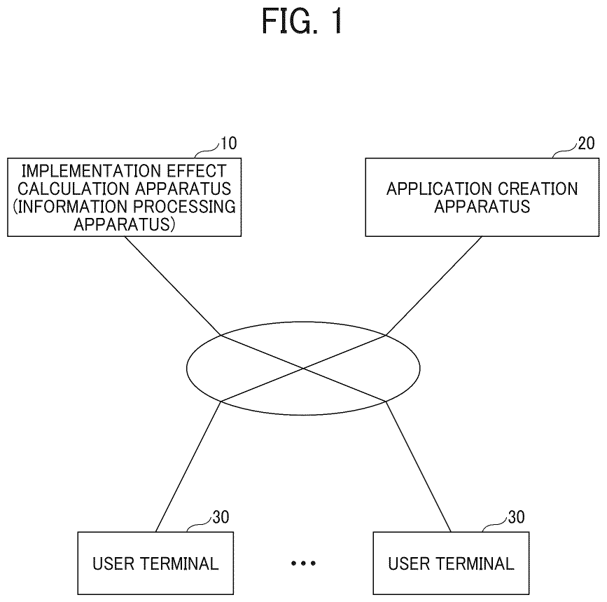

FIG. 1 is a diagram illustrating an example of a configuration of a system according to a first embodiment. In FIG. 1, one or more user terminals 30 are connected to an application creation apparatus 20 and an implementation effect calculation apparatus 10 via a network such as a local area network (LAN) or Internet. The implementation effect calculation apparatus 10 is connected to the application creation apparatus 20 via the network such as the LAN or the Internet.

The application creation apparatus 20 is implemented by one or more computers that provide a service for assisting a user in creating an application (hereinafter, referred to as an “application creation service”) with node codes or low codes. In creating the application, the user determines arrangement positions of one or more fields for receiving input of values to be registered as records on a screen. The service may be provided as a cloud service. In the present embodiment, an application used for a particular work in business (hereinafter, referred to as a “business application”) will be described as an example of a creation target. However, the present embodiment is applicable to any application used for a purpose other than business.

The user of the application creation service arranges any one or more fields among a plurality of kinds of previously prepared fields (i.e., setting items) on a screen (i.e., a form) of the business application and sets names (hereinafter, referred to as “field names”) for the respective fields via a graphical user interface (GUI). In this manner, the application creation service allows the user to create the business application that records, in a database, a record including values input to the respective fields in association with the respective field names of the fields. The kinds of fields are distinguished from one another by the type of the value input to each field. Examples of the type include a character string, a numerical value, and an attachment.

The user terminal 30 is an information terminal used by the user who uses the application creation apparatus 20 to create a business application. In response to an instruction from the user, the user terminal 30 requests the implementation effect calculation apparatus 10 to calculate the implementation effect of the business application. The implementation effect of the business application refers to an effect (e.g., a reduction effect in time and financial costs) evaluated based on a difference between a time spent for a particular work when the particular work is performed without using the business application (hereinafter, referred to as “before-implementation spent time”) and a time spent for the particular work when the particular work is performed using the business application (hereinafter, referred to as “after-implementation spent time”).

The implementation effect calculation apparatus 10 is an example of an information processing apparatus, and is implemented by one or more computers that calculate the implementation effect of the business application in a predetermined period.

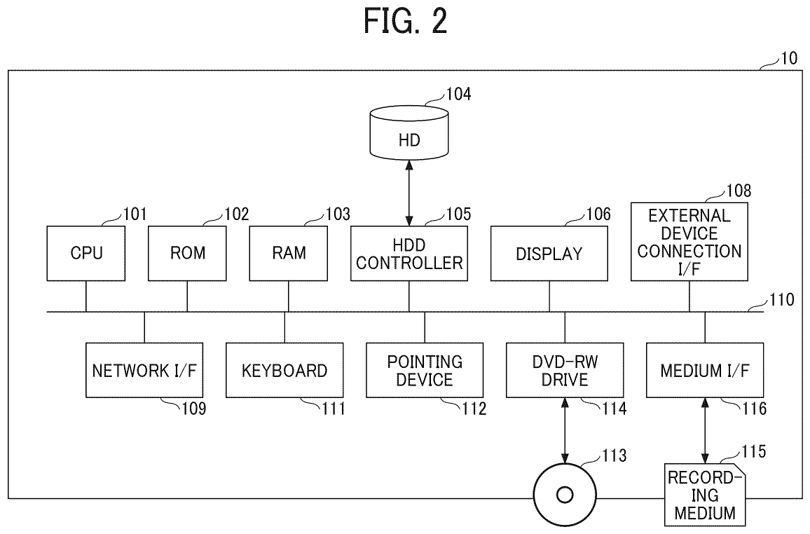

FIG. 2 is a diagram illustrating an example of a hardware configuration of the implementation effect calculation apparatus 10 according to the first embodiment. The implementation effect calculation apparatus 10 is implemented by a computer. As illustrated in FIG. 2, the implementation effect calculation apparatus 10 includes a central processing unit (CPU) 101, a read-only memory (ROM) 102, a random access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk rewritable (DVD-RW) drive 114, and a medium I/F 116.

The CPU 101 controls the overall operation of the implementation effect calculation apparatus 10. The ROM 102 stores a program used for booting the CPU 101, such as an initial program loader (IPL). The RAM 103 is used as a work area for the CPU 101. The HD 104 stores various kinds of data such as a program. The HDD controller 105 controls reading or writing of various kinds of data from or to the HD 104 under control of the CPU 101. The display 106 displays various types of information such as a cursor, a menu, a window, text, or an image. The external device connection I/F 108 is an interface for connecting various external devices to the implementation effect calculation apparatus 10. Examples of the external devices include a Universal Serial Bus (USB) memory and a printer.

The network I/F 109 is an interface that enables data communication via a communication network. The data bus 110 is a bus such as an address bus or a data bus, which electrically connects the components, such as the CPU 101 illustrated in FIG. 2, to each other.

The keyboard 111 is an example of an input device including a plurality of keys with which characters, numerical values, or various instructions are input. The pointing device 112 is an example of an input device with which, for example, selecting or executing various kinds of instructions, selecting a target for processing, or moving a cursor are performed. The DVD-RW drive 114 controls reading or writing of various kinds of data from or to a DVD-RW 113, which is an example of a removable recording medium. The removable recording medium is not limited to a DVD-RW and may be, for example, a digital versatile disc recordable (DVD-R). The medium I/F 116 controls reading or writing (storing) of data from or to a recording medium 115 such as a flash memory.

The application creation apparatus 20 and the user terminal 30 may also have a hardware configuration similar to that illustrated in FIG. 2. The application creation apparatus 20 and the implementation effect calculation apparatus 10 may be implemented by the same computer. In this case, a single computer system includes functional blocks of the application creation apparatus 20 and functional blocks of the implementation effect calculation apparatus 10.

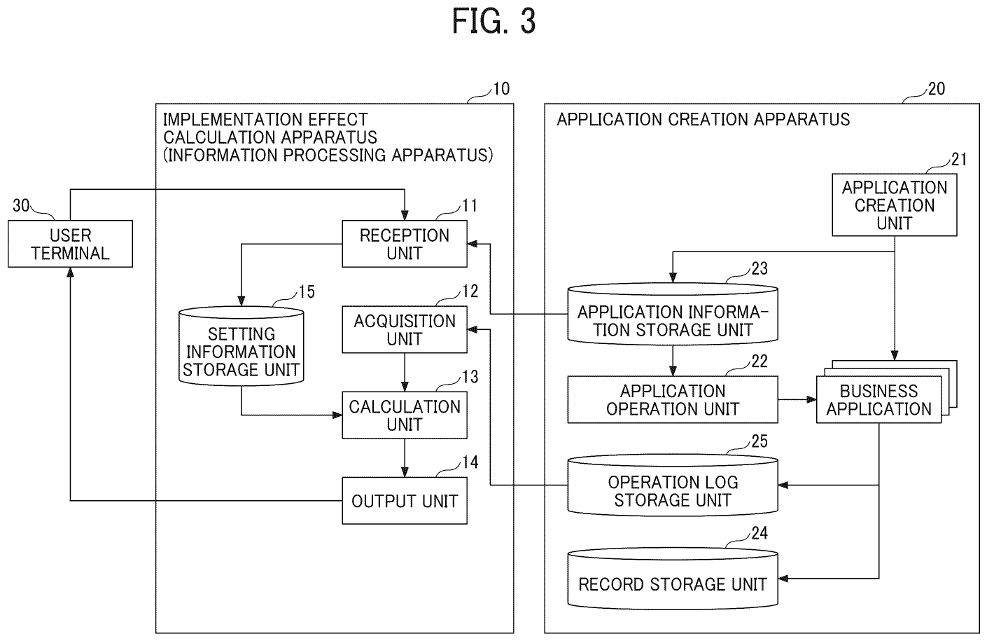

FIG. 3 is a diagram illustrating an example of a functional configuration of the application creation apparatus 20 and the implementation effect calculation apparatus 10 according to the first embodiment. In FIG. 3, the application creation apparatus 20 includes an application creation unit 21 and an application operation unit 22. These units are implemented by processes executed by a CPU of the application creation apparatus 20 based on one or more programs installed on the application creation apparatus 20. The application creation apparatus 20 further includes an application information storage unit 23, a record storage unit 24, and an operation log storage unit 25. These storage units may be implemented, for example, by an auxiliary storage device of the application creation apparatus 20 such as a HD or a storage device connectable to the application creation apparatus 20 via a network.

The application creation unit 21 provides the user terminal 30 with a GUI (e.g., a web page) for creating a business application, and receives input of information (hereinafter, referred to as “input information”) for use in creation of the business application from the user. Specifically, the application creation unit 21 receives input of arrangement positions of any one or more fields among a plurality of types of previously prepared fields, on a form (i.e., screen) of the business application, and field names of the respective fields. The application creation unit 21 receives input of a name of the business application to be created and an icon representing the business application. Thus, the input information includes the application name, the icon (icon name), and the field name and position information of each arranged field.

Based on the input information, the application creation unit 21 creates the business application. Specifically, the application creation unit 21 creates the business application and generates information (hereinafter, referred to as “application information”) on the created business application. The created business application executes a process of displaying a screen including each field arranged for the business application, receiving input of a value of each field via the screen, and registering, in a database, the value input in each field in association with the field name of the field.

The application creation unit 21 stores the generated application information in the application information storage unit 23. The application information includes an application name, an application ID, an icon, and field information of each field. The field information includes a field name, a type of the field, and position information of the field on the form.

The application operation unit 22 generates a screen of the business application selected to be used by the user of the user terminal 30, based on the application information of the business application, and causes the user terminal 30 to display the screen. The application operation unit 22 reports an operation performed via the screen to the business application.

In accordance with the operation reported from the application operation unit 22, the business application performs an operation on a record corresponding to the business application and records log information (hereinafter, referred to as an “operation log”) indicating the details of the operation in the operation log storage unit 25. The operation performed on a record is, for example, addition, deletion, or editing of the record.

The record storage unit 24 stores, for each business application, a database (hereinafter, referred to as an “application DB”) in which records corresponding to the business application are recorded.

The implementation effect calculation apparatus 10 includes a reception unit 11, an acquisition unit 12, a calculation unit 13, and an output unit 14. These units are implemented by processes executed by the CPU 101 based on one or more programs installed on the implementation effect calculation apparatus 10. The implementation effect calculation apparatus 10 further includes a setting information storage unit 15. The setting information storage unit 15 may be implemented by, for example, the HD 104 or a storage device that is connectable to the implementation effect calculation apparatus 10 via a network.

The reception unit 11 receives input (setting) of a first value or a second value. The first value is for use in calculating a difference between the before-implementation spent time, which is a time spent by the user to perform a particular work without using the business application, and the after-implementation spent time, which is a time spent by the user to perform the particular work using the business application. The second value indicates the difference. The reception unit 11 records received setting information in the setting information storage unit 15. The first value (i.e., the before-implementation spent time and the after-implementation spent time) will be described below as the setting information. However, the second value may be the setting information.

The acquisition unit 12 acquires a use history (e.g., the number of records) registered in the record storage unit 24 by the business application used for the particular work in a predetermined period. In the first embodiment, the acquisition unit 12 acquires the number of records based on the operation logs (i.e., log information) recorded in the operation log storage unit 25.

The calculation unit 13 calculates, as the implementation effect of the business application, a reduction effect achieved by the use of the business application in the predetermined period. The reduction effect is based on the use history (i.e., the number of records) acquired by the acquisition unit 12 and the first value or based on the number of records and the second value.

The output unit 14 causes the user terminal 30 to output a screen that displays the reduction effect (i.e., the implementation effect) calculated by the calculation unit 13.

Example operations performed by any one of the application creation apparatus 20 or the implementation effect calculation apparatus 10 will be described below. For example, operation of creating a business application, performed by the application creation apparatus 20, will be described.

In response to an access to the application creation apparatus 20 from the user terminal 30, the application creation unit 21 of the application creation apparatus 20 causes the user terminal 30 to display a home screen of the application creation service.

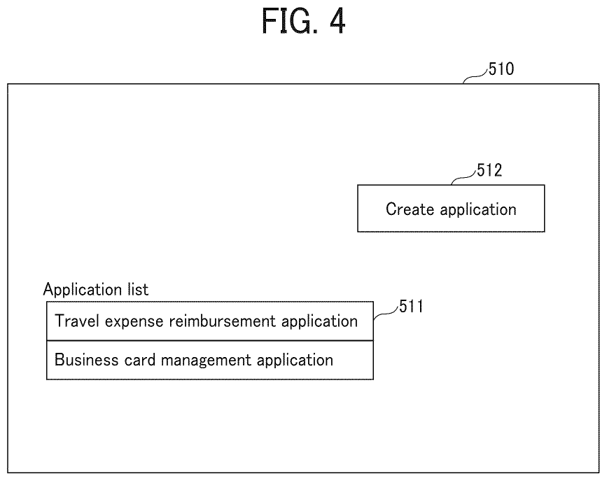

FIG. 4 is a diagram illustrating a display example of a home screen 510 of the application creation service. The home screen 510 of FIG. 4 includes an application list 511 and a create application button 512. The application list 511 is an area displaying a list of application names of business applications having been created. The application names of the created business applications are identifiable with reference to the application information storage unit 23.

The create application button 512 is a button for receiving an instruction to create a new business application.

In response to the user pressing the create application button 512, the application creation unit 21 causes the user terminal 30 to display a business application creation screen.

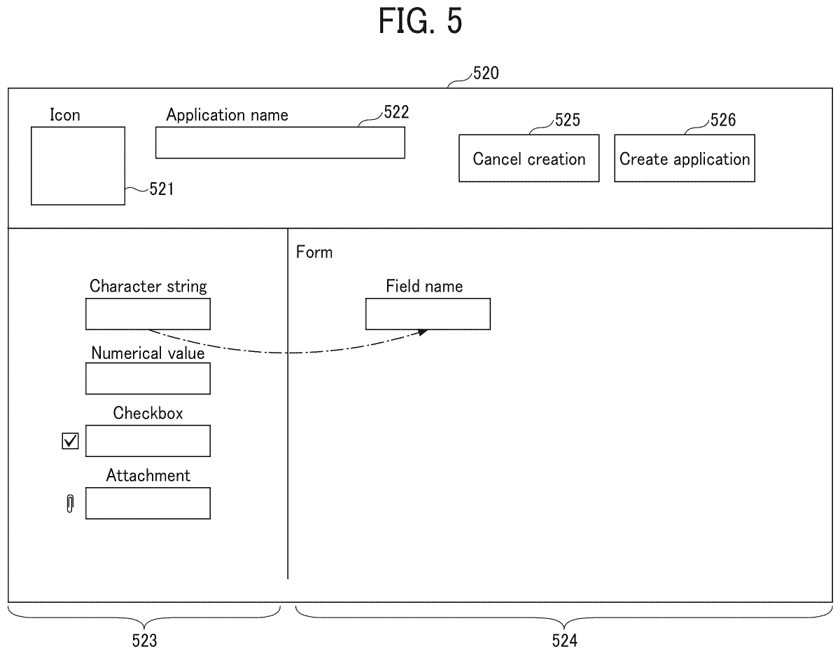

FIG. 5 is a diagram illustrating a display example of a business application creation screen 520. The business application creation screen 520 of FIG. 5 provides a predetermined format for creating a business application, and includes an icon area 521, an application name area 522, a field area 523, a form area 524, a cancel creation button 525, and a create application button 526. In other words, a business application is created based on the format of the business application creation screen 520.

The icon area 521 allows selection of an icon of a business application to be created (hereinafter, referred to as a “target application”) and displays the selected icon. Specifically, in an initial state, the icon area 521 displays an initial image. The initial image is an icon preset as an initial value. In response to the user performing a certain operation such as selecting the icon area 521, a list of selectable candidate icons is displayed. In response to the user selecting any one of the icons in the list, the selected icon is displayed in the icon area 521. This allows the user to set an icon suitable for the target application in the icon area 521 by customization.

The application name area 522 is an area for receiving input of a character string indicating the application name of the target application. In the initial state, an initial value (preset value) of the application name, for example, a “new business application”, is displayed in the application name area 522. This allows the user to input the application name suitable for the target application in the application name area 522 by customization.

The field area 523 displays a list of types of fields (hereinafter, referred to as “field types”) selectable as the field type of a field to be arranged in the target application.

The form area 524 corresponds to a form (screen) of the target application. In the initial state, nothing is arranged in the form area 524.

The cancel creation button 525 is a button for receiving an instruction to cancel the creation of the target application. The create application button 526 is a button for receiving an instruction to execute the creation of the target application.

For example, the user first performs an operation in the icon area 521 to select the icon of the target application. The user then inputs the application name of the target application in the application name area 522.

The user then drags and drops a field type among the field types included in the field area 523 to and at a given position in the form area 524 to arrange a field of the field type at the position at which the field type is dropped. The user sets a field name for the arranged field. When arranging a plurality of fields in the form of the target application, the user repeats the arrangement of a field type and the setting of a field name. FIG. 5 illustrates an example of the form area 524 in which a field of the type “character string”is arranged.

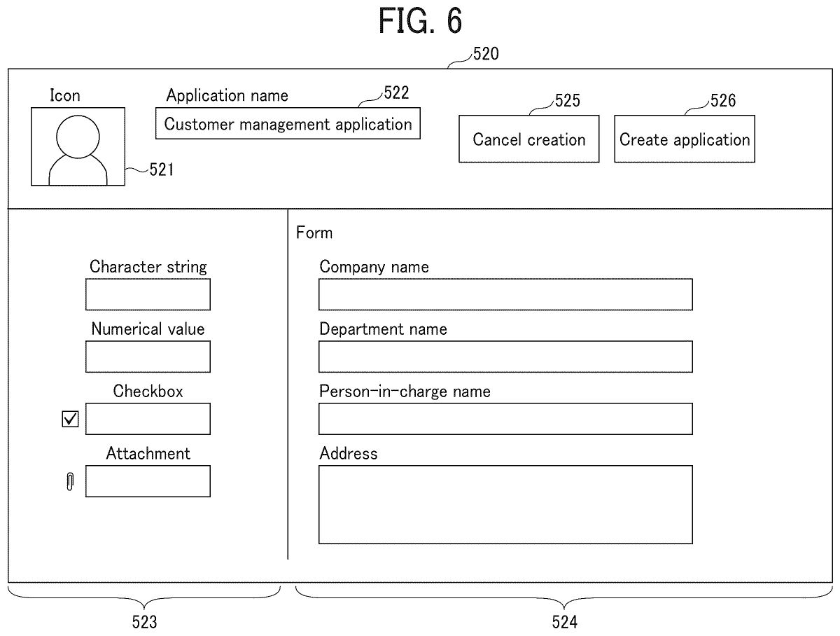

After the above-described work is completed, the business application creation screen 520 is, for example, in a state as illustrated in FIG. 6.

FIG. 6 is a diagram illustrating a display example of the business application creation screen after the business application creation work is finished. In FIG. 6, the same components as those in FIG. 5 are denoted by the same reference signs. FIG. 6 illustrates a state after the icon is selected and “customer management application” is input as the application name. FIG. 6 illustrates an example in which four fields having field names “company name”, “department name”, “person-in-charge name”, and “address” are arranged in the form area 524. Note that the type of these four fields is the character string. The business application having such fields is a business application that assists recording and management of customer information as indicated by the application name (“customer management application”).

The customer management application allows a user to input values to the respective fields and thus electronically record the customer information.

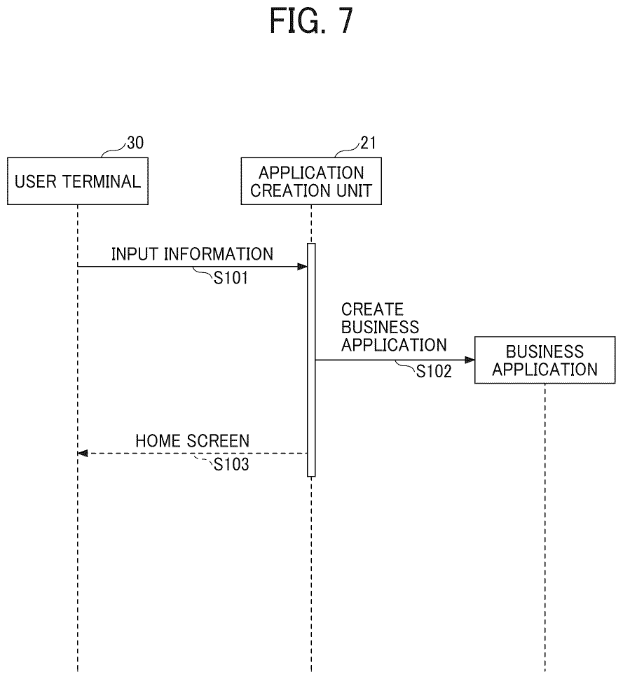

In response to pressing of the create application button 526 in the business application creation screen 520 in FIG. 6, the process illustrated in FIG. 7 is performed.

FIG. 7 is a sequence diagram of a business application creation process according to the first embodiment.

In step S101, in response to pressing of the create application button 526, the user terminal 30 transmits input information, which has been input on the business application creation screen 520, to the application creation apparatus 20. The input information includes the icon name of the icon displayed in the icon area 521, the application name displayed in the application name area 522, and field information on each field arranged in the form area 524.

In step S102, the application creation unit 21 of the application creation apparatus 20 creates a business application based on the input information. At this time, the application creation unit 21 generates application information based on the input information, and records the application information in the application information storage unit 23. The application information includes an application ID as well as the information included in the input information. Thus, the application information includes the application ID, the icon, the application name, and the field information on each field. The application creation unit 21 generates an application DB corresponding to the created business application in the record storage unit 24. Hereinafter, the application DB of the customer management application is referred to as a “customer management DB”. At this time, no record is registered in the customer management DB.

In step S103, the application creation unit 21 generates the home screen 510 again based on the list of application names stored in the application information storage unit 23, and causes the user terminal 30 to display the home screen 510.

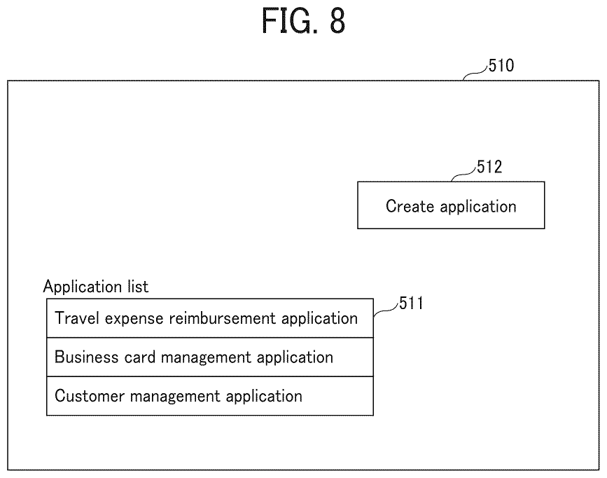

FIG. 8 is a diagram illustrating an example of the home screen updated after the business application is created. In FIG. 8, the same components as those in FIG. 4 are denoted by the same reference signs. In the home screen 510 in FIG. 8, the application name (i.e., the “customer management application”) of the new target application is added to the application list 511. The home screen 510 is displayed in common to users when the users use the existing business applications as well as when the users create a business application, and allows the users to select a business application to be used from the application list 511. The home screen 510 as illustrated in FIG. 8 allows not only the user who has created the customer management application but also other users to use the target application.

A use phase of the business application will be described.

For example, the user terminal 30 of the user who has created the customer management application or another user (hereinafter, either is referred to as an “application user”) displays the home screen 510 illustrated in FIG. 8. In this state, the application user selects the “customer management application” in the application list 511. In response to the selection, the customer management application causes the user terminal 30 to display an initial screen (hereinafter, referred to as an “application initial screen”) of the customer management application, based on the application information of the customer management application.

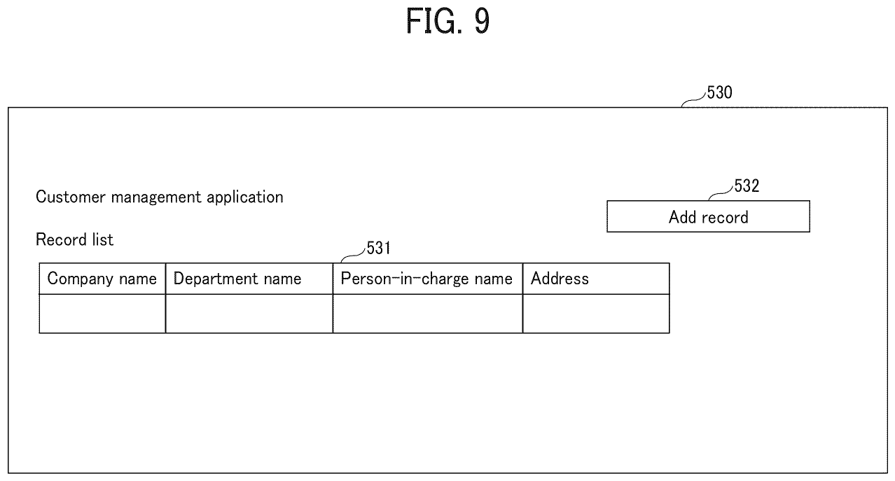

FIG. 9 is a diagram illustrating a display example of an application initial screen 530. The application initial screen 530 of FIG. 9 includes a record list area 531 and an add record button 532.

The record list area 531 displays a list of records registered in the customer management DB, based on values input by the application users of the customer management application in past. FIG. 9 corresponds to the initial use of the customer management application. Since no record is registered in the customer management DB, no record is displayed in the record list area 531.

The add record button 532 is a button for receiving an instruction to add (register) a new record (customer information) using the customer management application.

Thus, when the application user desires to input the customer information using the customer management application, the application user presses the add record button 532.

In response to the pressing of the add record button 532, the application creation unit 21 causes the user terminal 30 of the application user to display a main screen (hereinafter, referred to as an “application screen”) of the customer management application, based on the application information of the customer management application.

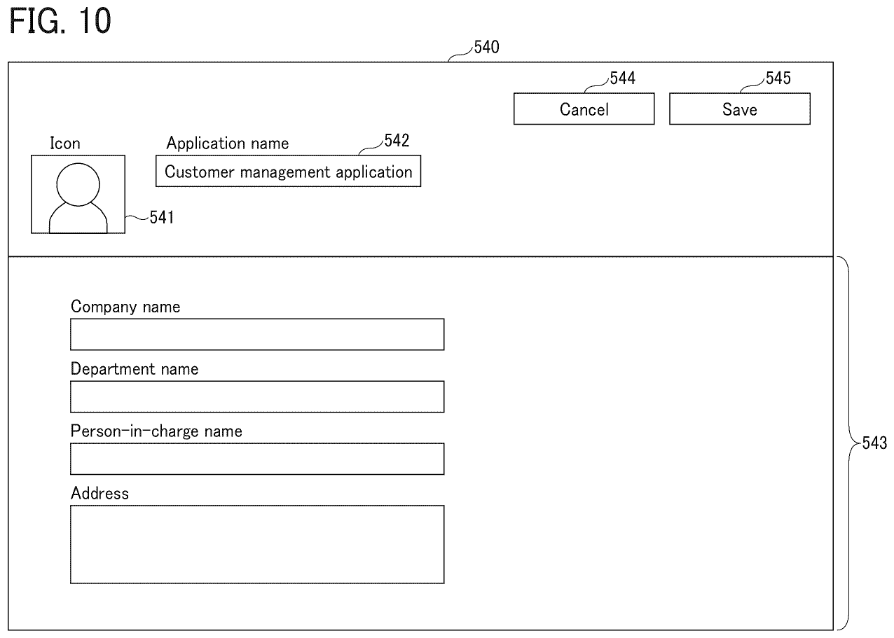

FIG. 10 is a diagram illustrating a display example of an application screen 540. The application screen 540 of FIG. 10 includes an icon area 541, an application name area 542, a form 543, a cancel button 544, and a save button 545. The icon area 541 displays the icon of the customer management application. The application name area 542 displays the application name of the customer management application. The form 543 includes the fields set for the customer management application and is for receiving input of a value via each field. Since FIG. 10 corresponds to FIG. 6, the fields arranged in the form area 524 in FIG. 6 are arranged in the form 543 in FIG. 10. The cancel button 544 is a button for receiving an instruction to cancel the input. The save button 545 is a button for receiving an instruction to save the value input in each field.

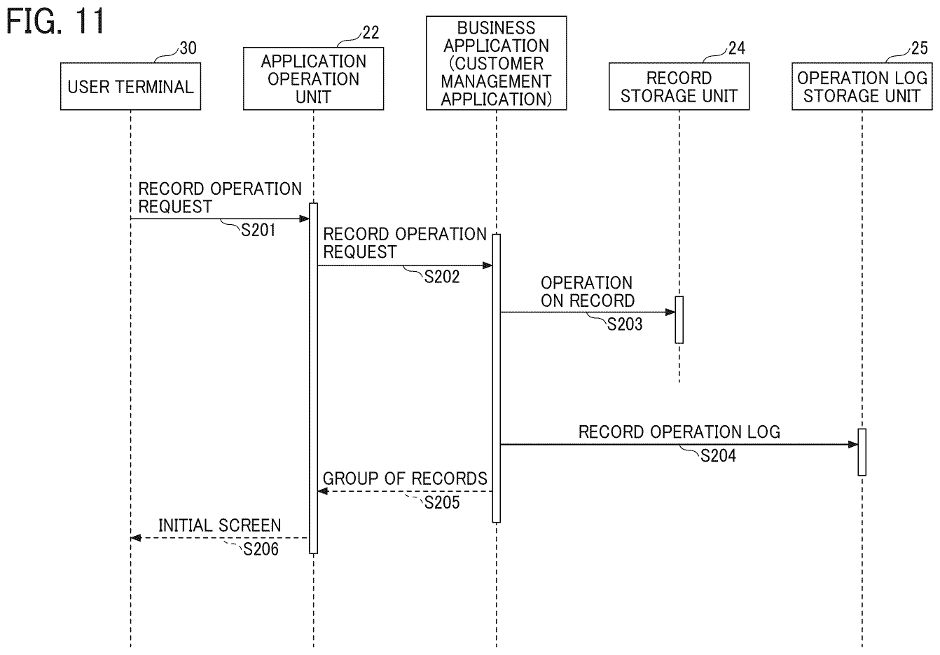

In response to the input of the value in each field and the pressing of the save button 545, the process illustrated in FIG. 11 is performed.

FIG. 11 is a sequence diagram of an example process performed with execution of the business application.

In response to pressing of the save button 545, in step S201, the user terminal 30 transmits a record operation request to the application creation apparatus 20. The record operation request includes the application ID of the business application to be used (in this example, the “customer management application”). In the case where the save button 545 is pressed in the application screen 540 in FIG. 10, the record operation request is “record addition”, and includes the value input in each field in association with the field name of the field. Examples of the operation performed on a record include “record editing” and “record deletion”as well as “record addition”.

In step S202, the application operation unit 22 transmits the record operation request to the customer management application corresponding to the application ID included in the record operation request. In step S203, the customer management application performs an operation corresponding to the record operation request on an application DB (i.e., the customer management DB) corresponding to the customer management application in the record storage unit 24.

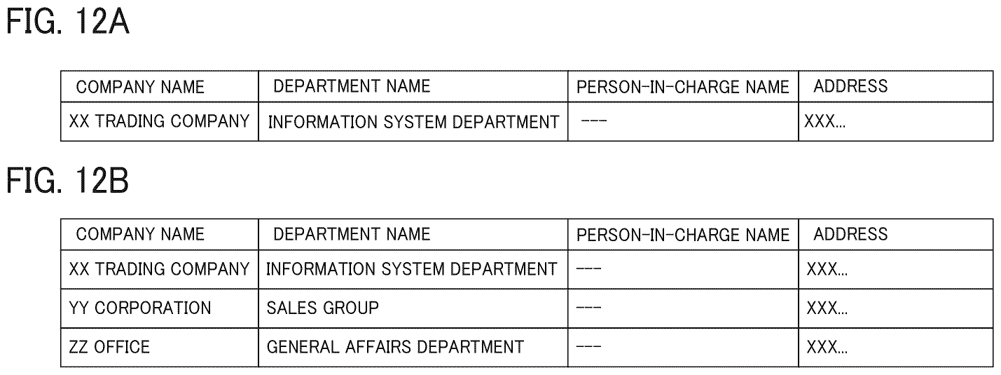

FIGS. 12A and 12B are diagrams each illustrating an example of a configuration of the customer management DB. As illustrated in FIGS. 12A and 12B, the customer management DB is a database that stores a record that includes the value input to each field in association with the field name of the field set in the customer management application. FIG. 12A illustrates the customer management DB in which the first record has been registered.

FIG. 12B illustrates the customer management DB in which a plurality of records have been registered by the repetition of the process illustrated in FIG. 11.

In step S204, the customer management application records an operation log indicating the details of this operation performed on the customer management DB, in the operation log storage unit 25.

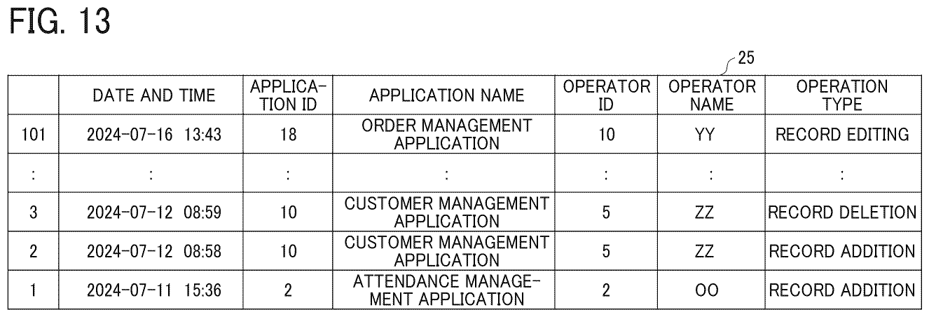

FIG. 13 is a diagram illustrating an example of a configuration of the operation log storage unit 25. One row in FIG. 13 corresponds to one operation log. One operation log includes items such as a date and time, an application ID, an application name, an operator ID, an operator name, and an operation type. The date and time indicates a date and time at which an operation was performed on a record. The application ID indicates an application ID of the business application (i.e., the customer management application in the case of FIG. 11) that performed the operation on the record. The application name is an application name of the business application. The operator ID and the operator name respectively indicate the ID and the name of the user of the user terminal 30 that issued the record operation instruction. The operation type is information indicating which of “record addition”, “record editing”, or “record deletion” the operation corresponds to. When the process of FIG. 11 is performed in response to pressing of the add record button 532 in the application initial screen 530, the operation type is “record addition”.

In step S205, the customer management application transmits all the records registered in the customer management DB, to the application operation unit 22. In step S206, the application operation unit 22 generates the application initial screen 530 again based on the records, and causes the user terminal 30 to display the application initial screen 530.

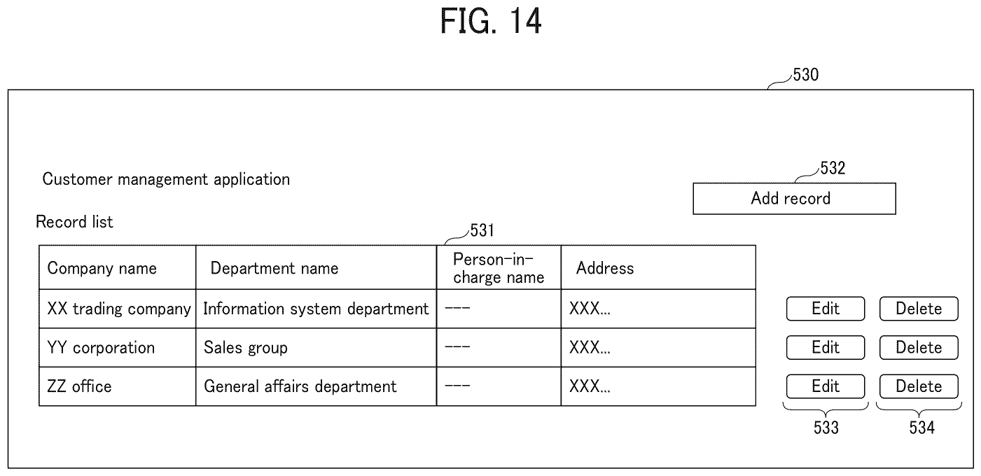

FIG. 14 is a diagram illustrating a display example of the application initial screen when one or more records are present. In FIG. 14, the same components as those in FIG. 9 are denoted by the same reference signs, and the description of these components is omitted as appropriate.

The application initial screen 530 in FIG. 14 corresponds to the customer management DB in the state illustrated in FIG. 12B. Thus, the record list area 531 includes the records illustrated in FIG. 12B. For each record, an edit button 533 and a delete button 534 are additionally displayed.

The edit button 533 is a button for receiving an instruction to edit the corresponding record.

Editing of a record refers to changing the values of one or all of the items (fields) of the record. In response to pressing of the edit button 533 for any one of the records, the application operation unit 22 causes the user terminal 30 to display the application screen 540 (see FIG. 10) for the record serving as a processing target. In this case, the value registered in the record is displayed in each field of the application screen 540. In response to the user changing the values of the one or more fields and pressing the save button 545, the process similar to that in FIG. 11 is performed. In step S203, the customer management application changes the values in the record serving as the processing target, instead of adding a new record. In step S204, the customer management application records an operation log including “record editing”as the operation type.

In the application initial screen 530 (see FIG. 14), the delete button 534 is a button for receiving an instruction to delete the corresponding record. Deletion of a record refers to deleting the record from the customer management DB. In response to pressing of the delete button 534 for any one of the records, the process similar to that in FIG. 11 is performed. In step S201, the user terminal 30 issues a request to delete the record. In step S203, the customer management application deletes the record from the customer management DB. In step S204, the customer management application records an operation log including “record deletion”as the operation type.

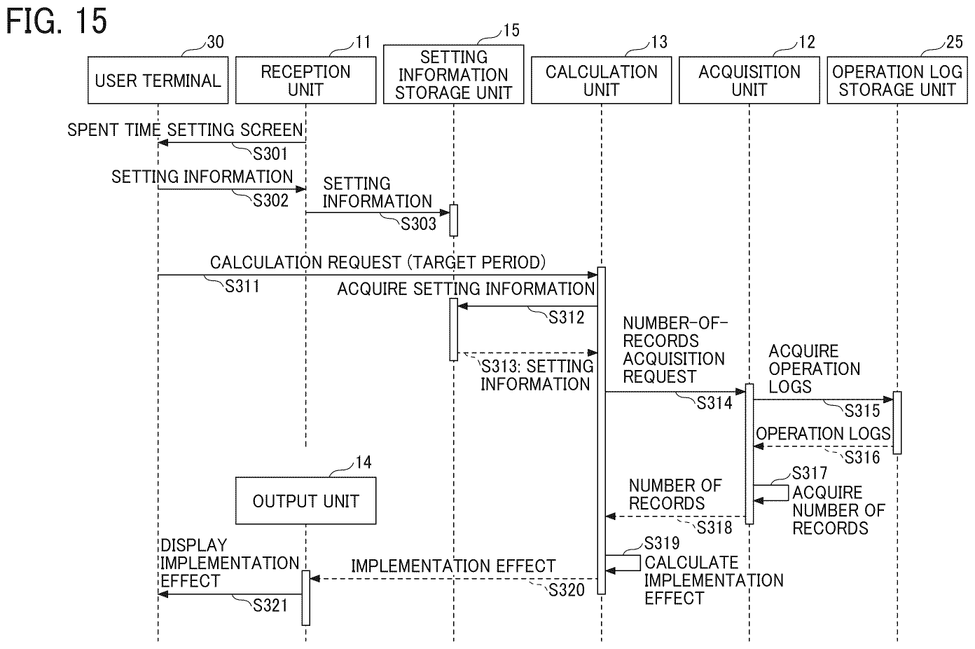

Calculation of the implementation effect of a business application will be described. FIG. 15 is a sequence diagram of an implementation effect calculation process for the business application according to the first embodiment.

In step S301, the reception unit 11 of the implementation effect calculation apparatus 10 causes the user terminal 30 to display a screen (hereinafter, referred to as a “spent time setting screen”) that allows the user to set the before-implementation spent time and the after-implementation spent time for each business application. Step S301 may be performed in response to a request, which is transmitted from the user terminal 30, for example, in response to input performed on the user terminal 30 by the user.

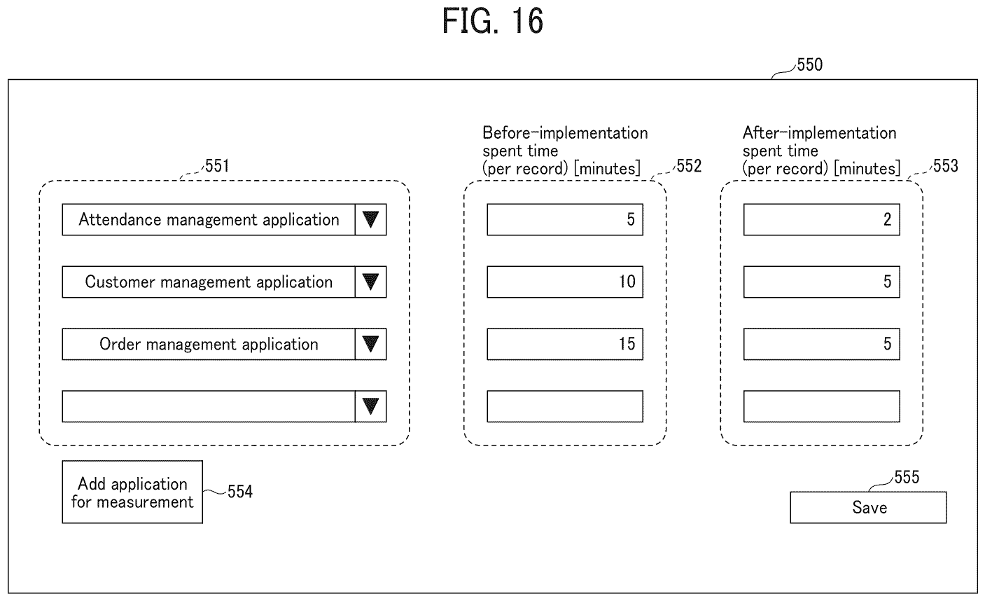

FIG. 16 is a diagram illustrating a display example of the spent time setting screen according to the first embodiment. In FIG. 16, a spent time setting screen 550 includes an application selection area 551, a before-implementation spent time setting area 552, an after-implementation spent time setting area 553, an add button 554, and a save button 555.

The application selection area 551 includes one or more pull-down lists and makes, for each pull-down list, a business application of which the implementation effect is to be calculated selectable. One pull-down list includes, as options, the application names included in the respective application information stored in the application information storage unit 23.

The before-implementation spent time setting area 552 is an area for receiving input (setting) of the before-implementation spent time for the business application selected in each pull-down list in the application selection area 551.

The after-implementation spent time setting area 553 is an area for receiving input (setting) of the after-implementation spent time for the business application selected in each pull-down list in the application selection area 551.

The before-implementation spent time for a certain business application refers to a time spent for a work corresponding to registration of one record of the business application (e.g., in the case of the customer management application, a work for recording single customer information in a predetermined document or database) before the business application is implemented. The after-implementation spent time for a certain business application refers to a time spent to register one record using the business application. No strict measurement may be performed for the before-implementation spent time and the after-implementation spent time, and values evaluated according to the sense of the users may be used.

The add button 554 is a button for receiving an instruction to add an input area of one row for the application selection area 551, the before-implementation spent time setting area 552, and the after-implementation spent time setting area 553.

The save button 555 is a button for receiving an instruction to save information (hereinafter, referred to as “setting information”) input (set) in the application selection area 551, the before-implementation spent time setting area 552, and the after-implementation spent time setting area 553. The setting information includes, for each business application of which the implementation effect is to be calculated, the application ID, the application name, the before-implementation spent time, and the after-implementation spent time.

FIG. 16 illustrates an example in which both the before-implementation spent time and the after-implementation spent time are input. However, the input related to the before-implementation spent time and the after-implementation spent time is not limited to this example. It is sufficient to identify a time reduced after the implementation of the business application from the time spent before the implementation of the business application, that is, a difference in time before and after the implementation of the business application, from the input of the user. Thus, the user may input the difference between the before-implementation spent time and the after-implementation spent time or may input the before-implementation spent time and an after-implementation reduction rate for calculation of the difference in time. The before-implementation spent time and the after-implementation spent time are an example of a first value. The before-implementation spent time and the after-implementation reduction rate are equivalent to an example of the first value. The difference between the before-implementation spent time and the after-implementation spent time is an example of a second value.

In response to input to the spent time setting screen 550 and pressing of the save button 555, the user terminal 30 transmits the setting information to the implementation effect calculation apparatus 10 in step S302.

When receiving (accepting) the setting information, the reception unit 11 of the implementation effect calculation apparatus 10 saves the setting information in the setting information storage unit 15 in step S303. Accordingly, the application ID, the application name, the before-implementation spent time, and the after-implementation spent time are saved in the setting information storage unit 15 for each business application of which the implementation effect is to be calculated.

Thereafter, the process in step S311 and the subsequent processes are performed at a given timing of the user. At the start of step S311, the user terminal 30 displays a screen (hereinafter, referred to as an “implementation effect calculation instruction screen” for receiving an instruction to calculate the implementation effect from the user.

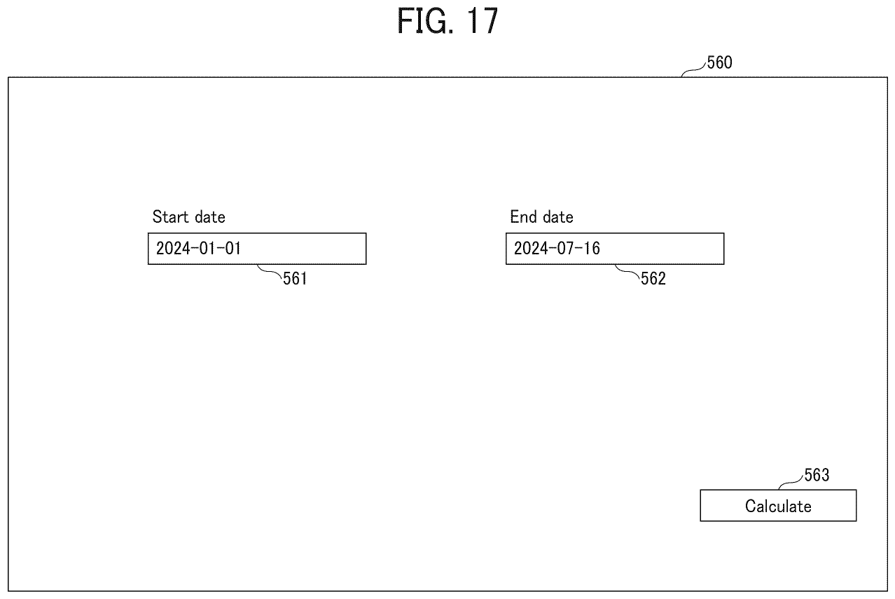

FIG. 17 is a diagram illustrating a display example of an implementation effect calculation instruction screen 560 according to the first embodiment.

The implementation effect calculation instruction screen 560 of FIG. 17 includes a start date input area 561, an end date input area 562, and a calculate button 563.

The start date input area 561 is an area for receiving input of the start date of a period (hereinafter, referred to as a “target period”) for which the implementation effect is to be calculated. The end date input area 562 is an area for receiving input of the end date of the target period. The calculate button 563 is a button for receiving an instruction to calculate the implementation effect in the target period.

In response to the user inputting the start date and the end date of the target period and pressing the calculate button 563, in step S311, the user terminal 30 transmits an implementation effect calculation request to the implementation effect calculation apparatus 10. The implementation effect calculation request includes target period information (e.g., the start date and the end date).

In response to receiving the implementation effect calculation request, in steps S312 and S313, the calculation unit 13 of the implementation effect calculation apparatus 10 acquires the setting information (e.g., the application ID, the application name, the before-implementation spent time, and the after-implementation spent time of each business application of which the implementation effect is to be calculated) from the setting information storage unit 15.

In step S314, the calculation unit 13 designates a set of application IDs included in the setting information, and transmits a number-of-records acquisition request for each business application (hereinafter, referred to as a “target application”) whose application ID is included in the set to the acquisition unit 12. The number of records of a business application refers to the number of records stored in the application DB of the business application. The number of records of a business application is an example of a use history registered by the business application. The use history may be, for example, the number of times of login or the number of times a process using an application has been performed.

In response to the number-of-records acquisition request, in steps S315 and S316, the acquisition unit 12 acquires all the operation logs from the operation log storage unit 25. Based on the acquired operation logs, in step S317, the acquisition unit 12 acquires (calculates) the use history (e.g., the number of records) for each target application. In step S318, the acquisition unit 12 transmits the use history (e.g., the number of records) for each target application to the calculation unit 13. As described above, the number of records is calculated based on the operation logs. In other words, the operation logs are also an example of the use history.

Based on the before-implementation spent time and the after-implementation spent time received by the reception unit 11 and the use history (e.g., the number of records) acquired for each target application by the acquisition unit 12, in step S319, the calculation unit 13 calculates the implementation effect of the target application in the target period. In step S320, The calculation unit 13 transmits the calculated implementation effect to the output unit 14.

In step S321, the output unit 14 causes the user terminal 30 to output (display) the implementation effect. For example, the output unit 14 generates a screen (hereinafter, referred to as an “implementation effect output screen”) including the implementation effect, and causes the user terminal 30 to display the implementation effect output screen.

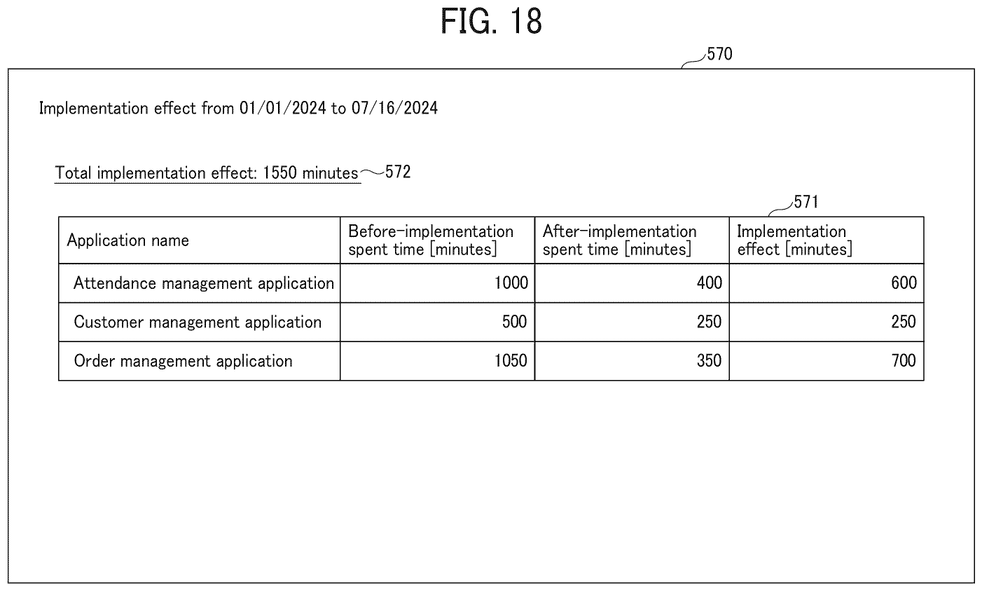

FIG. 18 is a diagram illustrating a display example of an implementation effect output screen 570 according to the first embodiment. The implementation effect output screen 570 of FIG. 18 includes an application-specific output area 571 and a total implementation effect output area 572.

The application-specific output area 571 presents, for each target application, the before-implementation spent time and the after-implementation spent time in the target period and the implementation effect in the target period.

The total implementation effect output area 572 presents the total implementation effect. The total implementation effect is the sum of the implementation effects (i.e., spent time reduction effects) of the respective target applications.

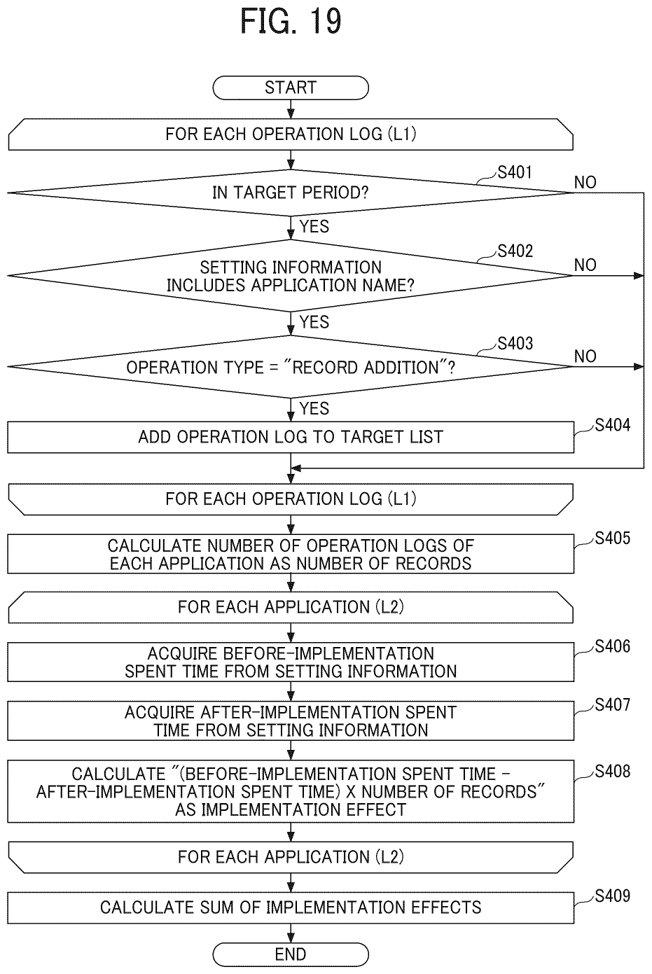

Details of steps S317 and S319 will be described. FIG. 19 is a flowchart of an example of the number-of-records acquisition process and the implementation effect calculation process for the business application according to the first embodiment. Steps S401 to S405 in FIG. 19 correspond to the number-of-records acquisition process performed by the acquisition unit 12 in step S317 in FIG. 15.

For each operation log acquired from the operation log storage unit 25 (see FIG. 13), the acquisition unit 12 performs loop processing L1 including steps S401 to S404. The operation log to be processed in the loop processing L1 is hereinafter referred to as a “target log”.

In step S401, the acquisition unit 12 determines whether the “date and time” of the target log is in the target period. If the “date and time” of the target log is in the target period (Yes in step S401), the acquisition unit 12 determines whether the setting information includes the “application name” of the target log in step S402. That is, it is determined whether the business application related to the target log is the target application. The application ID may be used instead of the application name. If the setting information includes the “application name” of the target log (Yes in step S402), the acquisition unit 12 determines whether the “operation type” of the target log is “record addition” in step S403. That is, it is determined whether the target log is an operation log that has been recorded in response to addition of a record to the application DB. If the “operation type” of the target log is “record addition” (Yes in step S403), the acquisition unit 12 adds the target log to a target list in step S404. The target list refers to data having a list structure for storing operation logs to be used for counting the number of records of the target application. In the initial state, the target list is empty.

If the “date and time” of the target log is not in the target period (No in step S401), if the setting information does not include the “application name” of the target log (No in step S402), or if the “operation type” of the target log is not “record addition” (No in step S403), the acquisition unit 12 does not add the target log to the target list.

After the loop processing L1 is performed for all the operation logs, the target list includes the operation logs that have been recorded in response to the respective records being added by each target application in the target period. In this state, the acquisition unit 12 classifies the operation logs in the target list by the target application, and uses the number of operation logs for each target application as the number of records of the target application in step S405. That is, since the operation logs included in the target list have been recorded at the time of the addition of the respective records, the number of records is estimated by counting the number of operation logs.

Subsequent steps S406 to S409 correspond to the implementation effect calculation process performed by the calculation unit 13 in step S319 in FIG. 15.

For each target application whose operation logs are included in the target list, the calculation unit 13 performs loop processing L2 including steps S406 to S408. A target application to be processed in the loop processing L2 is hereinafter referred to as a “target application X”.

In step S406, the calculation unit 13 acquires the before-implementation spent time of the target application X from the setting information. In step S407, the calculation unit 13 acquires the after-implementation spent time of the target application X from the setting information. In step S408, the calculation unit 13 performs a calculation of “(before-implementation spent time −after-implementation spent time) ×number of records” to obtain the calculation result as the implementation effect of the target application X. That is, the calculation unit 13 calculates, as the implementation effect (i.e., reduction effect), a third value that is a product of the number of records and a difference between the before-implementation spent time and the after-implementation spent time. The “number of records” used in this calculation is the number of records acquired for the target application X in step S405.

After the loop processing L2 is performed for all the target applications, the implementation effects are calculated for the respective target applications. In this state, the calculation unit 13 calculates the sum of the implementation effects of the respective target applications in step S409.

In the process described above, information to be included in the implementation effect output screen 570 (see FIG. 18) is obtained.

As described above, according to the first embodiment, the implementation effect of a business application is successfully calculated based on the number of records registered by the business application and a difference between a time spent for a work before the business application is implemented and a time spent for the work after the business application is implemented. Therefore, the reduction effect achieved by the application is successfully calculated based on the use history (e.g., the number of records) of the application.

The number of records is calculated from the operation logs. Accordingly, information on the number of records of each business application is successfully obtained without accessing the corresponding application DB.

A second embodiment of the present disclosure will be described below. In the second embodiment, differences from the first embodiment will be described. Accordingly, the configuration not mentioned in particular may be substantially the same as that in the first embodiment.

In the first embodiment, the number of operation logs each having the operation type of “record addition” is used as the number of records. Since a record may be deleted, a record that is deleted may have been registered by mistake. Since the record that has been deleted no longer exists in the application DB, the number of operation logs of “record addition” does not necessarily strictly match the number of records in the application DB. In the second embodiment, an example in which deleted records are excluded from the number of records used in calculating the implementation effect in consideration of such a possibility will be described. In this way, the implementation effect is expected to be calculated more accurately.

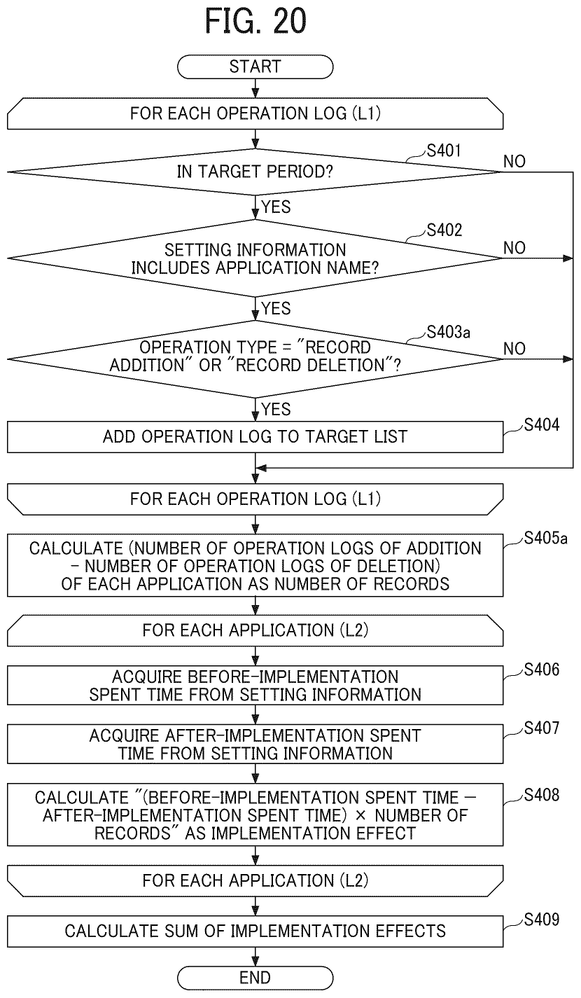

In the second embodiment, the process of FIG. 19 is replaced by the process of FIG. 20. FIG. 20 is a flowchart of an example of a number-of-records acquisition process and an implementation effect calculation process for a business application according to the second embodiment. In FIG. 20, the same steps as those in FIG. 19 are denoted by the same step numerals, and the description of these steps is omitted as appropriate.

In FIG. 20, steps S403a and 405a replace steps S403 and S405 of FIG. 19, respectively.

In step S403a, the acquisition unit 12 determines whether or not the “operation type” of the target log is either “record addition” or “record deletion”. If the “operation type” of the target log is either “record addition” or “record deletion” (Yes in step S403a), the acquisition unit 12 adds the target log to the target list in step S404. Thus, in the second embodiment, the operation logs of each target application related to either “record addition” or “record deletion”are added to the target list.

In step S405a, the acquisition unit 12 classifies the operation logs in the target list to operation logs of “record addition” and operation logs of “record deletion” for each target application, and uses a value obtained by subtracting the number of operation logs of “record deletion” from the number of operation logs of “record addition” for each target application to obtain the number of records of the target application. Consequently, the number of records of the target application no longer includes the number of deleted records.

The subsequent processing is the same as that in the first embodiment. Thus, in step S408, the implementation effect is calculated based on the number of records thus obtained.

A third embodiment will be described below. In the third embodiment, differences from the first embodiment will be described. Accordingly, the configuration not mentioned in particular may be substantially the same as that in the first embodiment.

In each embodiment described above, the example of evaluating the implementation effect of a business application based on the work time reduced by the implementation of the business application has been described. In the third embodiment, an example of including an economic cost reduction in consideration of a labor cost in the implementation effect will be described.

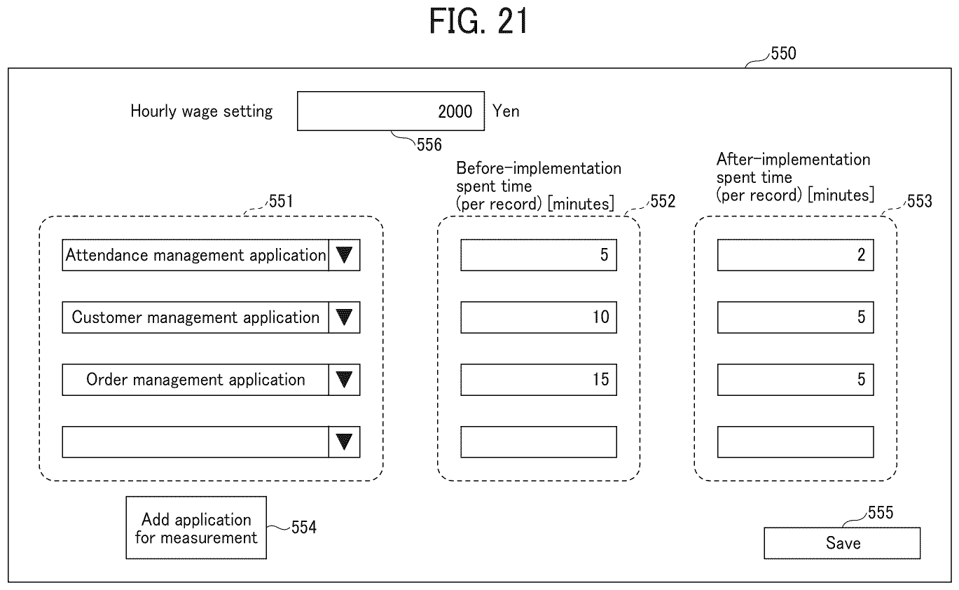

In the third embodiment, the configuration of the spent time setting screen 550 differs from that illustrated in FIG. 16. FIG. 21 is a diagram illustrating a display example of the spent time setting screen according to the third embodiment. In FIG. 21, the same components as those in FIG. 16 are denoted by the same reference signs, and the description of these components is omitted as appropriate.

The spent time setting screen 550 illustrated in FIG. 21 further includes an hourly wage setting area 556. The hourly wage setting area 556 is an area for receiving input of a wage by the hour (hereinafter, simply referred to as an “hourly wage”) that is an example of a labor cost of a person (hereinafter, referred to as a “worker”) who performs a work using a business application. The value of the hourly wage to be input may be, for example, an average value of hourly wages of workers in an organization or an hourly wage of a specific worker. In the third embodiment, the same spent time setting screen 550 as that in FIG. 16 may be used. In this case, for example, the average value in the industry or a predetermined fixed value may be used as the hourly wage. However, setting the hourly wage in the spent time setting screen 550 enables the reduced cost to be calculated more accurately in accordance with a user environment.

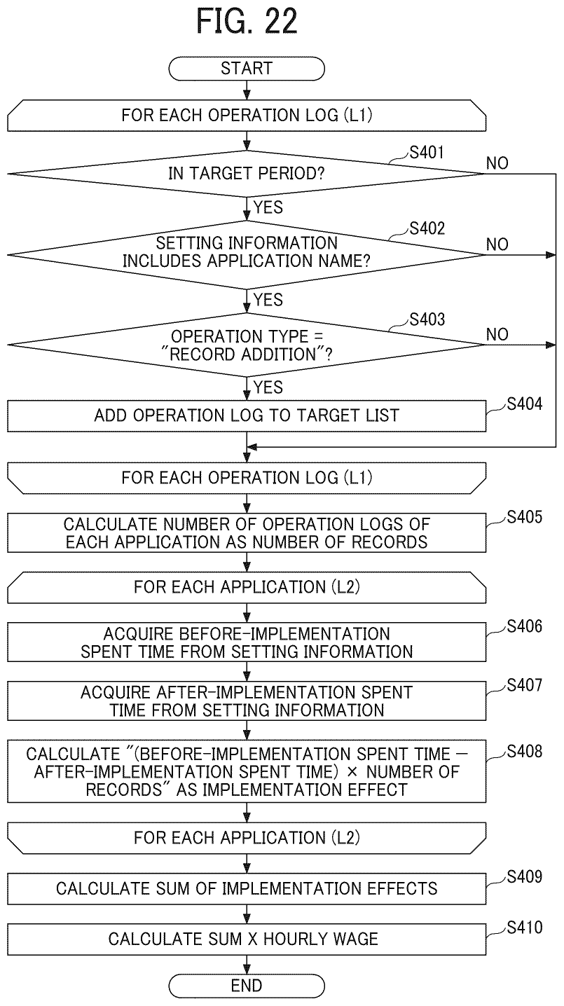

The process of FIG. 19A is replaced by the process of FIG. 22. FIG. 22 is a flowchart of an example of a number-of-records acquisition process and an implementation effect calculation process for a business application according to the third embodiment. In FIG. 22, the same steps as those in FIG. 19 are denoted by the same step numerals, and the description of these steps is omitted as appropriate.

In FIG. 22, step S410 is added as the last step. In step S410, the calculation unit 13 multiplies the sum calculated in step S409 by the hourly wage to calculate a reduced cost (i.e., a fourth value). At this time, when the sum is in units of minutes, a value obtained by dividing the sum by 60 is multiplied by the hourly wage.

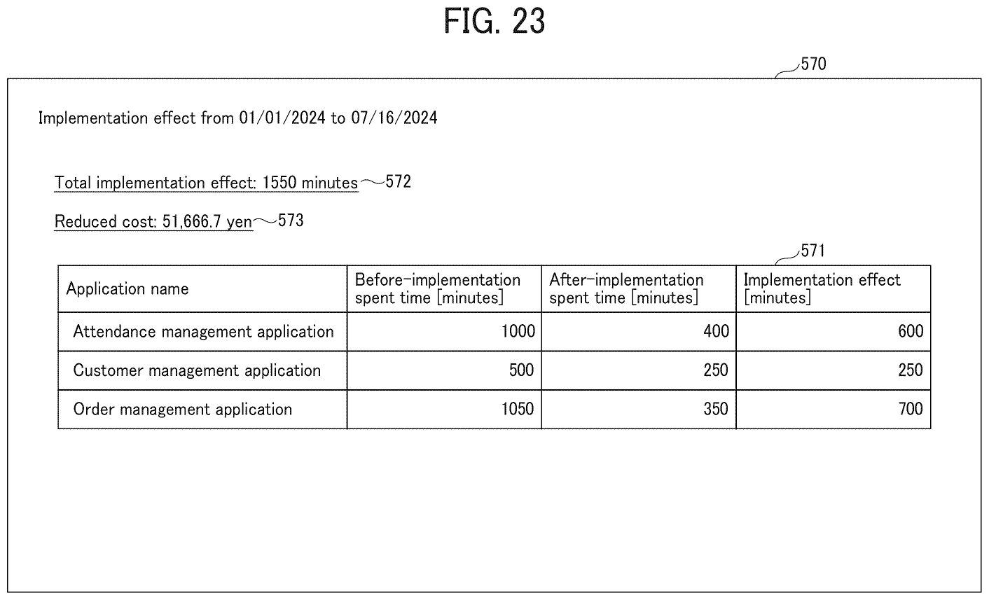

Consequently, in step S321 in FIG. 15, the implementation effect output screen 570 illustrated in FIG. 23 is displayed on the user terminal 30.

FIG. 23 is a diagram illustrating a display example of an implementation effect output screen 570 according to the third embodiment. In FIG. 23, the same components as those in FIG. 18 are denoted by the same reference signs, and the description of these components is omitted as appropriate. The implementation effect output screen 570 illustrated in FIG. 23 further includes a reduced cost display area 573. The reduced cost display area 573 is an area that displays the reduced cost calculated in step S410 in FIG. 22.

As described above, according to the third embodiment, the implementation effect of a business application is successfully presented to the user from an economical perspective.

The third embodiment may be combined with the second embodiment.

A fourth embodiment will be described below. In the fourth embodiment, differences from each embodiment described above will be described. Accordingly, the configuration not mentioned in particular may be substantially the same as that in each embodiment described above.

In each embodiment described above, the example of calculating the number of records in the application DB of each business application from the operation logs has been described. However, when each application DB is accessible from the outside, the acquisition unit 12 may count and directly acquire the number of records in the application DB.

In this case, in response to a number-of-records acquisition request transmitted from the calculation unit 13 in step S314 in FIG. 15, the acquisition unit 12 acquires, for each target application, the number of records from the application DB of the target application. The acquisition unit 12 transmits the acquired number of records to the calculation unit 13 in step S318.

As described above, substantially the same advantageous effects as those of each embodiment described above can be obtained also in the fourth embodiment.

A fifth embodiment will be described below. In the fifth embodiment, differences from each embodiment described above will be described. Accordingly, the configuration not mentioned in particular may be substantially the same as that in each embodiment described above.

In the fifth embodiment, an example will be described in which the user terminal 30 displays various screens via a web browser, and the implementation effect calculation apparatus 10 has a function of a web server that executes a web application. In the fifth embodiment, the business application is also a web application.

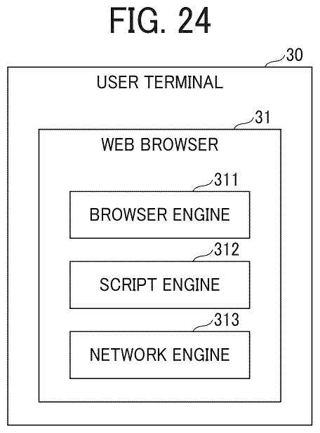

FIG. 24 is a diagram illustrating an example of a functional configuration of the user terminal 30 according to the fifth embodiment of the present disclosure. In FIG. 24, the user terminal 30 includes a web browser 31. The web browser 31 includes a browser engine 311, a script engine 312, and a network engine 313.

The browser engine 311 interprets Hypertext Markup Language (HTML) data and Cascading Style Sheets (CSS) data that form a web page, and displays the web page.

The script engine 312 executes a script (e.g., JavaScript®) included in the web page.

The network engine 313 transmits a Hypertext Transfer Protocol (HTTP) request and receives an HTTP response.

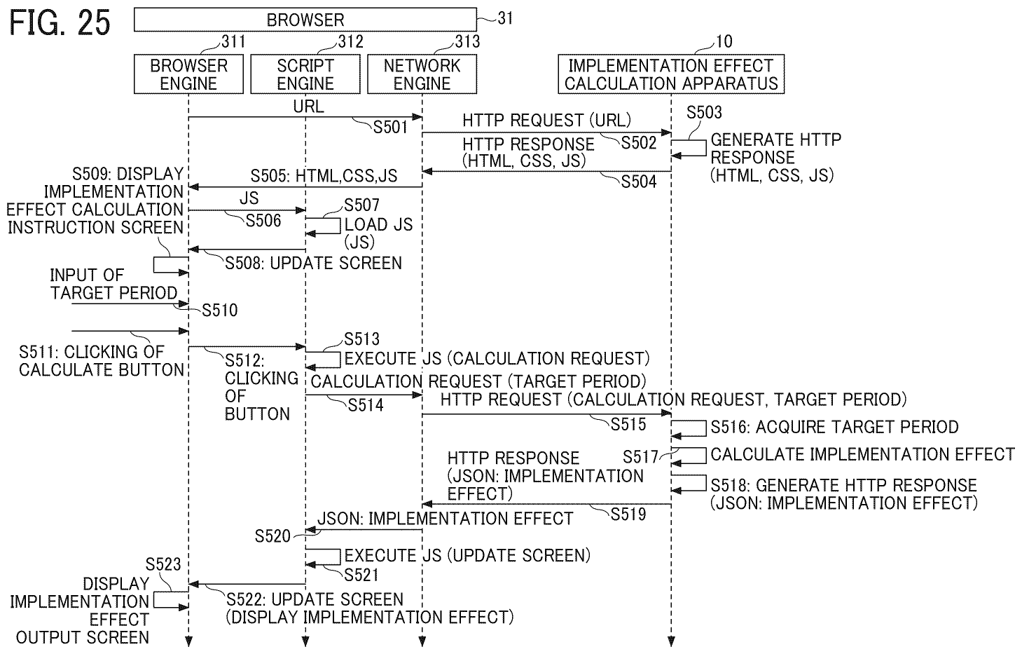

FIG. 25 is a sequence diagram of an example of an implementation effect calculation process for a business application according to the fifth embodiment. The sequence diagram of FIG. 25 presents a process corresponding to step S311 and the subsequent steps of the sequence diagram in FIG. 15. The steps S501 to S508 in FIG. 25 present a process of displaying the implementation effect calculation instruction screen 560 (see FIG. 17), which is not explicitly presented in FIG. 15.

In response to an instruction to display the implementation effect calculation instruction screen 560 (see FIG. 17) from the user, in step S501, the browser engine 311 inputs a Uniform Resource Locator (URL) to the network engine 313. The URL is associated with the display instruction and serves as a destination of an HTTP request addressed to the implementation effect calculation apparatus 10. In step S502, the network engine 313 transmits the HTTP request to the URL. For example, the URL may be registered as a bookmark in the web browser 31, associated with a menu of a menu screen provided by the implementation effect calculation apparatus 10, or directly input by the user.

In response to the HTTP request, in step S503, the output unit 14 of the implementation effect calculation apparatus 10 generates an HTTP response including web content data such as HTML data, CSS data, and a script (hereinafter, referred to as a “JS”). In step S504, the output unit 14 transmits the HTTP response to the user terminal 30.

The web content data is an example of web content data that is for displaying a first web page (e.g., the implementation effect calculation instruction screen 560 (see FIG. 17)) and a second web page (e.g., the implementation effect output screen 570 (see, for example, FIG. 18)) and that includes a script. The first web page receives input of data (e.g., the start date and the end date) for use in calculation of a predetermined period (e.g., the target period) for which the implementation effect is to be calculated and receives an instruction to calculate the implementation effect. The second web page displays the calculated implementation effect. The script causes execution of a process of transmitting the data input on the first web page to the implementation effect calculation apparatus 10 and a process of displaying the second web page that displays the implementation effect.

In response to receipt of the HTTP response transmitted in step S504, in step S505, the network engine 313 of the user terminal 30 inputs the HTML data, the CSS data, and the JS included in the HTTP response to the browser engine 311. The browser engine 311 inputs the JS, which is input thereto by the network engine 313, to the script engine 312 in step S506. The script engine 312 loads the JS in step S507 and requests the browser engine 311 to update the screen in step S508. Updating the screen includes displaying a new screen.

The HTTP response generated in step S503 may include a file name of the JS instead of the entity of the JS. In this case, the script engine 312 makes an access based on the file name and downloads the JS in step S507. This scheme is called a scheme of reading the JS as an external file.

The web content data is for displaying the first web page (e.g., the implementation effect calculation instruction screen 560 (see FIG. 17)) and the second web page (e.g., the implementation effect output screen 570 (see FIG. 18)), and includes the script. The first web page receives input of data (e.g., the start date and the end date) for use in calculation of the predetermined period (e.g., the target period) for which the implementation effect is to be calculated and receives an instruction to calculate the implementation effect. The second web page displays the calculated implementation effect. The script causes execution of at least the process of transmitting the data input on the first web page to the implementation effect calculation apparatus 10 and the process of displaying the second web page that displays the implementation effect. The script included in the web content data includes not only a JS directly written in HTML but also a JS to be downloaded in response to an access based on the file name by the scheme of reading the JS as an external file.

The browser engine 311 displays a web page, which is the implementation effect calculation instruction screen 560 (see FIG. 17), based on the HTML data and the CSS data in step S509.

In step S511, the browser engine 311 receives, via the implementation effect calculation instruction screen 560 (see FIG. 17) from the user, input of the start date and the end date of the target period in step S510 and receives clicking of the calculate button 563. In step S512, the browser engine 311 notifies the script engine 312 of the clicking of the calculate button 563. In response to the notification from the browser engine 311, the script engine 312 executes the JS in step S513, and inputs an implementation effect calculation request to the network engine 313 in step S514. The implementation effect calculation request includes target period information (e.g., the start date and the end date). The network engine 313 transmits an HTTP request serving as the implementation effect calculation request to the implementation effect calculation apparatus 10 in step S515. The HTTP request is an example of an HTTP request that is transmitted in response to execution of the JS by the user terminal 30 and that includes the data input on the implementation effect calculation instruction screen 560 (see FIG. 17) displayed by the user terminal 30 based on the web content data.

In response to receipt of the HTTP request, in step S516, the calculation unit 13 of the implementation effect calculation apparatus 10 acquires the start date and the end date from the HTTP request. In step S517, the calculation unit 13 calculates the implementation effect of each business application of which the implementation effect is to be calculated, in the target period from the start date to the end date. The calculation method may be substantially the same as that used in each embodiment described above.

The output unit 14, which is an example of a communication unit, generates an HTTP response including a JavaScript® Object Notation (JSON) describing the calculated implementation effect in step S518 so that the user terminal 30 executes the JS to display the implementation effect output screen 570 (see, for example, FIG. 18). The output unit 14 transmits the HTTP response to the user terminal 30 in step S519.

In response to receipt of the HTTP response, in step S520, the network engine 313 of the user terminal 30 inputs the implementation effect included in the HTTP response to the script engine 312. The script engine 312 executes the JS in step S521, and requests the browser engine 311 to update the content displayed on the web page in step S522. Based on the HTML data and the CSS data acquired in step S505, the browser engine 311 displays the implementation effect output screen 570 (see FIG. 18 or the like), which is the updated screen, in step S523.

As described above, in the fifth embodiment, the implementation effect calculation instruction screen 560 (see FIG. 17), the implementation effect output screen 570 (see FIG. 18), and execution of the processing in response to an operation on each of these screens are implemented by a single-page application. Specifically, when the implementation effect calculation instruction screen 560 is displayed, instead of web content data for displaying the implementation effect calculation instruction screen 560 alone, web content data for displaying the implementation effect calculation instruction screen 560 and the implementation effect output screen 570 and including a JS for executing a screen transition in accordance with an operation on the implementation effect calculation instruction screen 560 is distributed to the user terminal 30. Since the JS causes the screen transition from the implementation effect calculation instruction screen 560 to the implementation effect output screen 570, the user terminal 30 no longer downloads the web content data of the implementation effect output screen 570. With this configuration, an increased display speed of the implementation effect output screen 570 and a reduced communication load at the screen transition, can be expected.

A sixth embodiment will be described below. In the sixth embodiment, differences from the fifth embodiment will be described. Accordingly, the configuration not mentioned in particular may be substantially the same as that in the fifth embodiment.

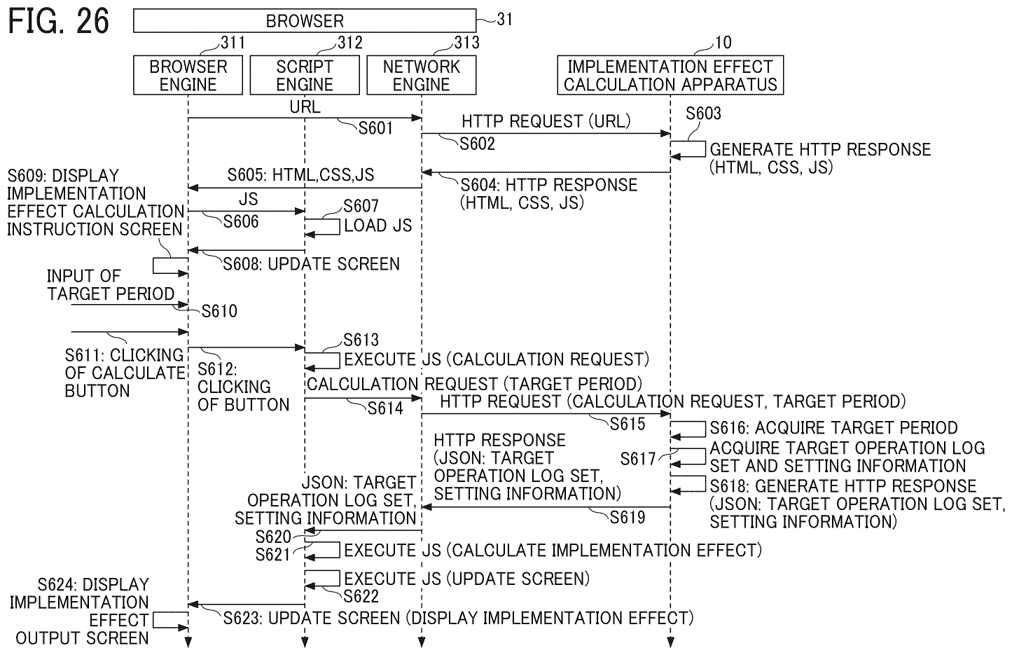

FIG. 26 is a sequence diagram of an implementation effect calculation process for a business application according to the sixth embodiment.

Steps S601 to S616 in FIG. 26 are substantially the same as steps S501 to S516 in FIG. 25, respectively. However, as will be apparent from the description below, a JS (script) included in an HTTP response generated in step S603 is different from that in the fifth embodiment.

In step S617, the calculation unit 13 acquires a target operation log set and setting information. The setting information includes the before-implementation spent time and the after-implementation spent time, for each business application of which the implementation effect is to be calculated, stored in the setting information storage unit 15. The target operation log set is a set of operation logs used in calculation of the implementation effect in the target period. When the implementation effect is calculated in the same manner as in the first embodiment, the target operation log set is a set of operation logs, of the business application of which the implementation effect is to be calculated, having the “operation type” of “record addition” and having the date and time in the target period. When the implementation effect is calculated in the same manner as in the second embodiment, the target operation log set is a set of operation logs, of the business application of which the implementation effect is to be calculated, having the “operation type” of either “record addition”or “record deletion”and having the date and time in the target period.

The output unit 14 generates an HTTP response including the target operation log set and the setting information in a JSON format in step S618. The output unit 14 transmits the HTTP response to the user terminal 30 in step S619.

In response to receipt of the HTTP response, in step S620, the network engine 313 of the user terminal 30 inputs the target operation log set and the setting information included in the HTTP response to the script engine 312.

In step S621, the script engine 312 performs processing associated with the input of the target operation log set and the setting information in the JS to calculate the implementation effect based on the target operation log set and the setting information. The method for calculating the implementation effect based on the target operation log set and the setting information may be substantially the same as that used in each embodiment described above.

As described above, the sixth embodiment differs from the fifth embodiment in that the JS further includes processing of calculating the implementation effect and the script engine 312 functions as the calculation unit 13. Thus, the user terminal 30 can also calculate the implementation effect. In other words, the user terminal 30 has the function of calculating, which is provided by the implementation effect calculation apparatus 10 in the above-described first to fifth embodiments. Accordingly, the implement effect calculation apparatus 10 in the sixth embodiment may be referred to as the information processing apparatus or the web server.

The script engine 312 performs processing associated with the end of the calculation of the implementation effect in the JS in step S622 to request the browser engine 311 to update the content displayed on the web page serving as the implementation effect calculation instruction screen 560 (see FIG. 17) in step S623. In step S624, the browser engine 311 displays the web page serving as the implementation effect output screen 570 (see, for example, FIG. 18), which is the updated screen, based on the HTML data and the CSS data acquired in step S605.

The example of the HTTP response including the target operation log set is presented above. However, the HTTP response may include the number of records calculated for each business application in step S405 in FIG. 19 or step S405a in FIG. 20. In this case, the processing for calculating the number of records is omitted from the JS.

As described above, according to the sixth embodiment, the user terminal 30 can calculate the implementation effect. This can reduce the processing load on the implementation effect calculation apparatus 10. When the implementation effect calculation instruction screen 560 is displayed, instead of web content data for displaying the implementation effect calculation instruction screen 560 alone, web content data for displaying the implementation effect calculation instruction screen 560 and the implementation effect output screen 570 and including a JS for executing a screen transition in accordance with an operation on the implementation effect calculation instruction screen 560 is distributed to the user terminal 30. Since the JS causes the screen transition from the implementation effect calculation instruction screen 560 to the implementation effect output screen 570, the user terminal 30 no longer downloads the web content data of the implementation effect output screen 570. Consequently, solutions to technical difficulties, such as an increased display speed of the implementation effect output screen 570 and a reduced communication load at the screen transition, can be expected.

The implementation effect calculation apparatus 10 is not limited to a general-purpose server computer. Examples of the implementation effect calculation apparatus 10 include, but not limited to, an output device such as a projector (PJ), an interactive whiteboard (IWB) which is a whiteboard having an electronic whiteboard function and a capability of mutual communication, or a digital signage, a head-up display (HUD) device, industrial machinery, an image-capturing device, a sound pickup device, medical equipment, a smart appliance, a notebook personal computer (PC), a mobile phone, a smartphone, a tablet terminal, a game machine, a personal digital assistant (PDA), a digital camera, a wearable PC, or a desktop PC.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in each embodiment above are merely one example of multiple computing environments that implement the one or more embodiments disclosed herein.

In some embodiments, the implementation effect calculation apparatus 10 includes multiple computing devices, such as a server cluster. The multiple computing devices communicate with one another through any type of communication link including a network, a shared memory, or the like and perform the processes disclosed herein. In substantially the same manner, the application creation apparatuses 20 may include multiple computing devices that communicate with one another.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

According to Aspect 1, an information processing apparatus that executes an application for receiving input of data for a particular work includes a reception unit, a calculation unit, and an output unit. The reception unit receives input of a first value or a second value. The first value is for use in calculating a difference between a time spent by a user to perform the particular work using the application and a time spent by the user to perform the particular work without using the application. The second value indicates the difference. The calculation unit calculates a reduction effect achieved by use of the application in a predetermined period. The reduction effect is based on a use history of the application used for the particular work in the predetermined period and the first value or is based on the use history and the second value. The output unit causes an information terminal to output a screen that displays the reduction effect calculated by the calculation unit.

According to Aspect 2, the information processing apparatus of Aspect 1 further includes an acquisition unit. The acquisition unit acquires the use history of the application for the predetermined period based on log information that is recorded in response to an operation on the application.

According to Aspect 3, in the information processing apparatus of Aspect 1 or 2, the reception unit further receives designation of the predetermined period from the user.

According to Aspect 4, in the information processing apparatus of any one of Aspects 1 to 3, the application includes a plurality of applications. The reception unit receives, for each of the plurality of applications, input of the first value or the second value. The calculation unit calculates a sum of reduction effects achieved by use of the plurality of applications in the predetermined period. The output unit causes the terminal to output a screen that displays the sum of the reduction effects.

According to Aspect 5, in the information processing apparatus of Aspect 4, the output unit causes the information terminal to output a screen that displays the reduction effect of each of the plurality of applications.

According to Aspect 6, in the information processing apparatus of any one of Aspects 1 to 5, the time spent by the user to perform the particular work using the application includes a time spent by the user to input the data for the particular work.

According to Aspect 7, in the information processing apparatus of any one of Aspects 1 to 6, the use history indicates a number of records registered by the application. The calculation unit calculates, as the reduction effect, a third value that is a product of the difference and the number of records.

According to Aspect 8, in the information processing apparatus of Aspect 7, the calculation unit calculates, as the reduction effect, a fourth value that is a product of the third value and a labor cost.

According to Aspect 9, an information processing method performed by an information processing apparatus that executes an application includes: receiving input of a first value or a second value. The first value is for use in calculating a difference between a time spent by a user to perform the particular work using the application and a time spent by the user to perform the particular work without using the application. The second value indicates the difference. The method further includes: calculating a reduction effect achieved by use of the application in a predetermined period. The reduction effect is based on a use history of the application used for the particular work in the predetermined period and the first value or is based on the use history and the second value. The method further includes causing an information terminal to output a screen that displays the reduction effect calculated by the calculating.

According to Aspect 10, a program causes an information processing apparatus that executes an application to perform an information processing method. The information processing method includes: receiving input of a first value or a second value. The first value is for use in calculating a difference between a time spent by a user to perform the particular work using the application and a time spent by the user to perform the particular work without using the application. The second value indicates the difference. The method further includes: calculating a reduction effect achieved by use of the application in a predetermined period. The reduction effect is based on a use history of the application used for the particular work in the predetermined period and the first value or is based on the use history and the second value. The method further includes causing an information terminal to output a screen that displays the reduction effect calculated by the calculating.

According to Aspect 11, an information processing apparatus that executes a web application includes a reception unit, a storage unit, a calculation unit, and a communication unit. The reception unit receives input of a first value or a second value. The first value is for use in calculating a difference between a time spent by a user to perform a particular work using the web application and a time spent by the user to perform the particular work without using the web application. The second value indicates the difference. The storage unit stores a use history of the web application used by the user to perform the particular work. The use history indicates dates. The calculation unit calculates a reduction effect achieved by use of the web application in a predetermined period. The communication unit communicates with an information terminal, and transmits web content data to the information terminal. The web content data is for displaying a first web page and a second web page and includes a script. The first web page receives input of data for use in calculation of the predetermined period and an instruction to calculate the reduction effect. The second web page displays the calculated reduction effect. The script causes execution of a process of transmitting the data input on the first web page to the information processing apparatus and a process of displaying the second web page that displays the reduction effect. In response to the communication unit receiving an HTTP request, the calculation unit calculates the reduction effect achieved in the predetermined period, based on the use history and the first value or the second value. The HTTP request is transmitted in response to execution of the script by the information terminal and includes the data input on the first web page displayed by the information terminal based on the web content data. The predetermined period is calculated based on the data included in the received HTTP request. The use history corresponds to one or more dates that fall in the predetermined period. The communication unit transmits an HTTP response to the information terminal so that the information terminal executes the script to display the second web page. The HTTP response is a response to the HTTP request and includes the calculated reduction effect.

According to Aspect 12, an information processing apparatus that executes a web application includes a reception unit, a storage unit, and a communication unit. The reception unit receives input of a first value or a second value. The first value is for use in calculating a difference between a time spent by a user to perform a particular work using the web application and a time spent by the user to perform the particular work without using the web application. The second value indicates the difference. The storage unit stores a use history of the web application used by the user to perform the particular work. The use history at least includes a date. The communication unit communicates with an information terminal. The communication unit transmits web content data to the information terminal. The web content data is for displaying a first web page and a second web page and includes a script. The first web page receives input of data for use in calculation of a predetermined period and an instruction to calculate a reduction effect achieved by use of the web application in the predetermined period. The second web page displays the calculated reduction effect. The script causes execution of a process of transmitting the data input on the first web page to the information processing apparatus, a process of calculating the reduction effect, and a process of displaying the second web page that displays the reduction effect. In response to the communication unit receiving an HTTP request, the communication unit transmits an HTTP response to the information terminal so that the information terminal executes the script to calculate the reduction effect and display the second web page. The HTTP request is transmitted in response to execution of the script by the information terminal and includes the data input on the first web page displayed by the information terminal based on the web content data. The HTTP response includes the use history of one or more dates that fall in the predetermined period and the first value or the second value.

1. An information processing apparatus for executing a web application, the apparatus comprising:
circuitry configured to acquire a difference between a time spent by a user to perform a particular work using the web application and a time spent by the user to perform the particular work without using the web application; and
a memory that stores a use history of the web application used by the user for the particular work,
wherein the circuitry is configured to:
transmit, to an information terminal, web content data for displaying a first web page and including a script,
the first web page for receiving an input of data for use in calculation of a predetermined period and an instruction to calculate a reduction effect achieved by use of the web application in the predetermined period;
receive a Hypertext Transfer Protocol (HTTP) request, which is transmitted from the information terminal in response to execution of the script, the HTTP request including the data input on the first web page displayed by the information terminal based on the web content data; and
transmit an HTTP response to the information terminal, the HTTP response including a use history of one or more dates that fall in the predetermined period and the difference,
the script further causing the information terminal to calculate the reduction effect based on the use history and the difference and to display a second web page including the reduction effect.

2. The information processing apparatus according to claim 1, wherein the circuitry is configured to
receive inputs of the time spent by the user to perform the particular work using the web application and the time spent by the user to perform the particular work without using the web application, and
calculate the difference based on the input times.

3. The information processing apparatus according to claim 2, wherein the circuitry is configured to acquire the use history of the web application for the predetermined period based on log information that is recorded in response to an operation on the web application.

4. The information processing apparatus according to claim 2, wherein the circuitry is further configured to receive designation of the predetermined period from the user.

5. The information processing apparatus of claim 2, wherein the web application includes a plurality of web applications, and the circuitry is configured to:
receive, for each of the plurality of web applications, the inputs of the time spent by the user to perform the particular work using the web application and the time spent by the user to perform the particular work without using the web application; and
cause the information terminal to calculate a sum of reduction effects each achieved by use of the web application in the predetermined period, and output a screen that displays the sum of the reduction effects.

6. The information processing apparatus of claim 5, wherein the circuitry causes the information terminal to output a screen that displays the reduction effect of each of the plurality of web applications.

7. The information processing apparatus of claim 2, wherein the time spent by the user to perform the particular work using the web application includes a time spent by the user to input the data for the particular work.

8. The information processing apparatus according to claim 2, wherein
the use history indicates a number of records registered by the web application, and
the reduction effect is a product of the difference and the number of records.

9. The information processing apparatus according to claim 2, wherein
the use history indicates a number of records registered by the web application, and
the reduction effect is a product of the difference, the number of records, and a labor cost.

10. The information processing apparatus according to claim 1, wherein the circuitry is configured to receive input of the difference from the user.

11. The information processing apparatus according to claim 10, wherein the circuitry is configured to acquire the use history of the web application for the predetermined period based on log information that is recorded in response to an operation on the web application.

12. The information processing apparatus according to claim 10, wherein the circuitry is further configured to receive designation of the predetermined period from the user.

13. The information processing apparatus according to claim 10, wherein the web application includes a plurality of web applications, and the circuitry is configured to:
receive, for each of the plurality of web applications, the inputs of the time spent by the user to perform the particular work using the web application and the time spent by the user to perform the particular work without using the web application; and
cause the information terminal to calculate a sum of reduction effects each achieved by use of the web application in the predetermined period, and output a screen that displays the sum of the reduction effects.

14. The information processing apparatus according to claim 13, wherein the circuitry causes the information terminal to output a screen that displays the reduction effect of each of the plurality of web applications.

15. The information processing apparatus according to claim 10, wherein the time spent by the user to perform the particular work using the web application includes a time spent by the user to input the data for the particular work.

16. The information processing apparatus according to claim 10, wherein the use history indicates a number of records registered by the web application, and the reduction effect is a product of the difference and the number of records.

17. The information processing apparatus according to claim 10, wherein
the use history indicates a number of records registered by the web application, and
the reduction effect is a product of the difference, the number of records, and a labor cost.

18. A system for executing a web application, comprising:
an information processing apparatus including:
apparatus circuitry configured to acquire a difference between a time spent by a user to perform a particular work using the web application and a time spent by the user to perform the particular work without using the web application; and
a memory that stores a use history of the web application used by the user for the particular work; and
an information terminal including terminal circuitry configured to:
receive, from the information processing apparatus, web content data including a script; and
display a first web page based on the web content data, the first web page for receiving an input of data for use in calculation of a predetermined period and an instruction to calculate a reduction effect achieved by use of the web application in the predetermined period;
wherein, in execution of the script, the terminal circuitry is further configured to:
transmit an HTTP request that includes the data input on the first web page to the information processing apparatus;
calculate a reduction effect based on an HTTP response received from the information processing apparatus, the HTTP response including a use history of one or more dates that fall in the predetermined period and the difference; and
display a second web page including the calculated reduction effect.

19. An information terminal comprising
circuitry configured to:
receive, from an information processing apparatus that executes a web application, web content data including a script; and
display a first web page based on the web content data, the first web page for receiving an input of data for use in calculation of a predetermined period and an instruction to calculate a reduction effect achieved by use of the web application in the predetermined period,
wherein, in execution of the script, the circuitry is further configured to:
transmit an HTTP request that includes the data input on the first web page to the information processing apparatus;
calculate a reduction effect based on an HTTP response received from the information processing apparatus,
the HTTP response including:
a use history of the web application used by a user for a particular work, the use history corresponding to one or more dates that fall in the predetermined period; and
a difference between a time spent by the user to perform the particular work using the web application and a time spent by the user to perform the particular work without using the web application; and
display a second web page including the calculated reduction effect.
